(19) United States
(12) Patent Application Publication
(10) Pub. No.: US 2016/0335628 A1
(43) Pub. Date: Nov. 17, 2016

(54) SYSTEM AND METHOD FOR DIGITAL CURRENCY STORAGE, PAYMENT AND CREDIT

(71) Applicant: Adam Mark Weigold, Stateline, NV (US)

(72) Inventor: Adam Mark Weigold, Stateline, NV (US)

(21) Appl. No.: 14/712,715

(22) Filed: May 14, 2015

(51) Int. Cl. G06Q 20/38; G06Q 20/06; G06Q 20/36

(52) U.S. Cl. CPC G06Q 20/3829; G06Q 20/3674; G06Q 20/065

(57) ABSTRACT

A system and method for the secure online storage of digital currency or crypto-currency assets, and the secure use of stored online digital currency assets for financial payment transactions and credit lending transactions in either digital currency or fiat currency. The present invention includes various methods for the encryption and secure online storage of a digital currency wallet using spliced/paired design architecture, and various methods for the integration of secure digital currency online wallets with online banking platforms, debit card devices, credit card devices, credit lending networks, merchant payment processors and credit card associations. The present invention also relates to the use of spliced/paired design architecture for non-financial applications that improve the online storage security of other types of data files and document files that are not related to digital currency or financial transactions.

### CROSS-REFERENCE TO RELATED APPLICATIONS

This application is related to and claims priority under 35 USC .sctn.119 from U.S. Provisional Application No. 61/994,053 filed May 15, 2014 entitled “SYSTEM AND METHOD FOR DIGITAL CURRENCY STORAGE, PAYMENT AND CREDIT” which is incorporated fully herein by reference.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### STATEMENT REGARDING PRIOR DISCLOSURES BY A JOINT INVENTOR

Not Applicable

### BACKGROUND OF THE INVENTION

1—Field of the Invention

The present invention relates to a system and method for the secure storage, payment and credit lending of digital currency or crypto-currency that uses traditional credit cards and debit cards for the convenient payment of goods and services from merchants in fiat currency, and automatically withdraws the converted funds from digital currency assets stored in a highly secure online digital wallet account.

2—Description of Related Art

Digital currencies or crypto currencies have recently emerged as an alternative to traditional fiat currencies and credit/debit card payment infrastructure. Fiat currencies typically represent the tradable currency of a particular nation such as the US dollar, or a group of nations such as the Euro. Trade in fiat currencies suffers the disadvantages of value manipulation by government, bank account fees, transaction fees and taxes, and a lack of privacy or anonymity. The involvement of traditional banks in the process dramatically slows transaction speed and increases costs for the customer. Moreover it is unnecessary from a technical point of view, given the instant world-wide online access now available to most banking customers via their internet connected computer or mobile phone device. Digital currencies have the potential to displace traditional banks from online banking and international banking markets.

The recent advent of digital currencies is primarily due to the desire for a fast, secure, transparent, easily tradable international currency that can be safely and instantaneously transferred online between users, is immune to manipulation by governments, involves no bank fees and provides increased privacy and anonymity for both the customer and vendor. Digital currency accounts or wallets have great potential to displace credit card and debit card accounts for many everyday transactions due to their lower cost and potentially safer use online. Digital or crypto currencies are typically valued on the transaction volume of the currency with each and every transaction being stored on a transaction ledger or software block-chain and validated by a peer-to-peer distributed network of computers. Using such a distributed network to validate every transaction prevents double payments, ensures a high level of security against transaction fraud and removes the need for trust in a third party to validate transactions.

The exchange value of a digital currency into a fiat currency may be determined purely via the laws of supply and demand. Some digital currencies such as Bitcoin supply new currency via the use of networked computer processing power to verify every transaction and manage the network in a process called “mining” that rewards block-chain validation with new currency. Demand is typically achieved via the analysis of the volume of all currency transactions. In a common embodiment all transactions are recorded in multiple nodes of a distributed network of computers or servers that simultaneously determine the instantaneous value of the currency at any one time. The value and date of every digital transaction is totally transparent because it is used by the entire computer network to determine the currency value and requires a majority of nodes to be validated. This results in vastly increased levels of security against transaction fraud as the value and date of every transaction is ultimately verified on every computer on the network. However the identity of both the customer and merchant, or the transmitter and receiver, are only known to themselves. This is typically achieved using a set of private and public cryptographic security keys or addresses. Consequently digital currency transactions are fast, secure, private and free of taxes and large bank fees. Examples of digital, virtual or crypto currencies include Bitcoin, Litecoin and Dogecoin and are described in many online publications and patent documents including Morgenstern et al. (2012) in U.S. Pat. No. 8,255,297.

A major problem facing mainstream adoption of digital currencies arises from the requirement for both parties involved in a transaction to use digital wallet software that consist of encoded public and private key software. This means that vendors or merchants need to have their own digital currency wallet and online payment processing system in order to accept payments in digital currency from customers. Consequently digital currency adoption is dependent upon its popularity and infrastructure adoption rate with merchants and vendors. This may take several decades to reach the merchant penetration rate of existing credit/debit card infrastructure. To circumvent this market barrier to widespread mainstream adoption digital currency debit cards have recently emerged to provide a method for merchants to accept digital currency from customers using existing debit card infrastructure. Digital currency debit cards enable customers to spend digital currency from their digital wallet everywhere they can use debit or credit cards, with one possible embodiment described by Oakes III et al (2013) in U.S. Pat. No. 8,577,805.

Digital currency debit cards require fast transaction approval that confirms the customers' account balance or spending limit as with traditional fiat currency debit card accounts. Furthermore, if the private electronic key for a digital currency account is lost, erased or stolen then the customer loses all their digital currency assets. Hence digital currency debit cards are typically designed in one of either two configurations to satisfy transaction approval requirements and asset security, namely (1) the customers' digital currency balance is stored locally on the debit card itself that acts as an offline or “cold” digital currency wallet, or (2) the customers' digital currency balance is stored online on a cloud-based server or “hot” wallet that can be accessed by the customer via computer or mobile device. The major drawback of configuration (1) is that the physical theft or loss of the debit card results in the total loss of all digital currency stored on the cold digital wallet. The major drawback of configuration (2) is that hot digital wallets are stored mobile devices or on internet connected computer servers that are highly susceptible to online theft from computer hacking and internet fraud. Moreover, if the private key of a digital wallet is stored on the customers' computer or mobile device it is usually even more susceptible to online theft. Hence the responsibility for digital currency asset security often lies entirely with the customer, which is a direct consequence of digital currency transactions having both public user anonymity and no trusted intermediary third party to validate transactions. Consequently both configurations of digital currency debit cards typically only store small amounts of digital currency that the customer can top up from more secure cold wallets or digital currency vaults. This adds extra time and inconvenience for the customer and also hinders the use of debit cards for larger transactions.

The inherent security drawbacks of existing digital currency debit card technologies mean they are not suitable for credit card accounts where creditors or lenders must accept the potential losses due security risks instead of the customer. There currently exists no secure digital currency wallet solution that satisfies the security risk requirements of credit lenders and the technical requirements of existing credit and debit card infrastructure. Consequently digital currency credit card products have not yet emerged in the market because of the significant potential for loss, fraud or theft of digital currency. There exists significant demand for a digital currency credit card product that requires no upfront funds from the customer, can be used for large transaction amounts, and can be reversed or repudiated by the customer in cases of non-delivery by merchants or vendors (unlike digital currency debit cards transactions which are typically non-reversible). However a digital currency credit card product requires significant digital currency assets or credit for lending to approved customers and a more secure digital currency wallet technology than is currently available with existing digital currency debit card products. For digital currency adoption to rival traditional fiat currency as a payment method a highly secure digital currency credit /debit card and online wallet technology is required.

### SUMMARY OF THE INVENTION

According to the present invention there is provided a system and method for an automated online digital currency payment, storage and credit lending platform that incorporates a cryptographically encoded or spliced/paired digital wallet account for the secure storage of all digital currency assets, traditional credit/debit card infrastructure for payment transactions in fiat currency with merchants, and a distributed peer-to-peer network of lenders to provide credit lending facilities to credit card customers. The present invention comprises traditional credit and debit card payment platforms with the secure online storage of digital currency in a spliced/paired digital wallet design. In addition to debit card accounts with highly secure digital currency storage, customers can also apply for credit card accounts with borrowed funds supplied through a distributed network or pool of lenders or investors. This pool of lenders or investors may, although this should not be seen as limiting the invention in any way, include the pool of customers who have digital currency assets stored in a debit card account encoded within the proprietary spliced/paired private key software code. The card issuer or vendor of the digital currency payment, storage and lending banking platform has the ability to charge fees for services including, but not limited to, payments and transactions, secure currency storage, account management and credit management services. One consequence of the present invention is that instead of being responsible for their own digital wallet asset security, the customer now entrusts that responsibility to the spliced/paired wallet technology and the credit/debit card issuer, wallet vendor or digital currency bank.

Ease of use and asset security levels offered by digital currency wallet technology is critical to the commercial feasibility of vendors to be able to offer customers digital currency credit cards, debit cards and other digital currency banking products. Conventional digital wallets such as online Bitcoin wallets typically comprise, but are not limited to, a private software key in excess of fifty characters long and a shorter public key or address around thirty characters long. The private key is required to access or use digital currency assets stored in accounts associated with the public address. Theft or loss of the private key typically results in the permanent loss of all digital currency assets. However loss of the public address is not detrimental as it can be recalculated or reformulated using the private key. Regardless of whether the private key is retained by the customer, the wallet vendor or both, if it is stored on any server, computer or mobile device that is connected to the internet it is vulnerable to online theft or loss. Consequently conventional online digital wallets are susceptible to internet theft, loss or deletion of the private key information which in practice commercially limits the amount of digital currency typically stored in an online wallet or debit card device. Although debit card accounts can be regularly topped up from safer offline digital wallet accounts this adds significant inconvenience for the customers, discourages use for larger transactions and makes digital currency credit card products too risky for credit card issuers and banking vendors.

The present invention incorporates a unique and novel digital wallet technology that can be described as a spliced/paired online wallet technology. In contrast to conventional online digital wallets the novel spliced/paired digital wallet design involves the private software key being separated or spliced into two separate smaller keys that can only access the contents of a digital wallet when paired together, but cannot access a digital wallet separately by themselves. The concept is for the customer to retain one spliced private key and the card issuer, wallet vendor or digital bank to retain the other spliced portion of the private key for trusted payment processing and storage backup services. Most of the time, when a transaction is not being executed, the spliced private key information stored on either the vendors computer server or the customers computer device is entirely useless to an online thief or computer hacker who is successful in penetrating computer security. The two spliced keys are only ever susceptible to online theft when they are temporarily paired together as a result of the customer executing a digital currency transaction via a credit card, debit card or software program that connects to the vendors' online platform server via the internet.

In the present invention, the paired private keys that temporarily exist on the vendors online server during transaction processing can also be stored as a back-up on the vendors offline server platform, cold wallet or digital currency vault which is never physically connected to the internet. Consequently the customers' digital currency assets can be fully protected against both online theft and loss. If the customer loses their spliced key information via the physical loss of a computer or mobile device, the accidental deletion of stored software files or the physical loss of a smart credit/debit card then the spliced key information can be restored on that device using the back-up paired key information stored on the vendors offline server network, cold wallet or digital vault. Consequently spliced/paired digital wallet technology represents a significant improvement in the security of digital assets against both theft and loss compared to conventional digital wallet technology. The dramatic reduction in risk for an online digital wallet technology in turn enables credit card accounts to be attractive and commercially feasible to vendors, credit card issuers, lenders and even investors. Furthermore, the risk profile of digital currency credit card products for the vendor in the present invention is totally eliminated when the funding of credit lending facilities is outsourced to a distributed peer-to-peer network of credit lenders and investors managed by the vendors online server network. This network of investors and lenders to credit card customers may include the vendors own debit card account customers as well as external investors and investor pools.

In a first embodiment of the present invention, although this should not be seen as limiting the invention in any way, a secure digital currency storage, payment and credit lending platform is provided to customers by a digital currency card issuer, banking institution or wallet vendor; and consists of eight distinct components of hardware and software, namely (1) a digital currency debit card issued to customers by the vendor, (2) a digital currency credit card issued to customers by the vendor, (3) a vendors online server platform that stores the vendors spliced private key information and runs the vendors software engine, (4) a vendors offline server network, cold wallet or digital vault that securely and regularly stores updates of the back-up copy of the paired private keys, (5) a customers portion of the spliced digital currency wallet account software stored on customers smart credit/debit card, computer, tablet or mobile device, (6) a software database of the vendors portion of the spliced digital currency wallet for all customers stored on the vendors online server platform or network, (7) a vendors software engine that performs customer validation, transaction validation, key coding/decoding, key splicing/pairing, account updates, payment processing, currency conversion, back-up file creation, and (8) a vendors peer-to-peer lending network that connects potential credit card customers with a pool of digital currency lenders and manages all customer credit card application approvals, contracts, fees and interest charges on behalf of the pool of lenders and investors.

In a second embodiment of the present invention the vendors offline server platform, or the eighth component, can also be used to store and validate customer card account balances and interface directly with credit card associations, which may have improved credit/debit card security benefits over the first embodiment.

In a third embodiment of the present invention the vendors database of spliced portions of customer private keys and user account information, or the sixth component, may exist as a software block-chain that is stored on a large distributed peer-to-peer network of customer computers instead of the vendors online server network. This configuration may have advantages in terms of providing an increased level security against theft or fraud over conventional digital wallets, without customers having to place total trust in the vendor for digital asset security. Nonetheless it may not have the same security levels offered by the first embodiment.

In a fourth embodiment of the present invention the customers debit cards and credit cards, or the first and second components, utilize smart card technology with embedded integrated circuitry. In this case the customers' spliced private key can be stored and updated directly on the card when being used for fiat currency transactions for faster transaction approval and processing at the time of the purchase. This embodiment may be preferred for improved customer convenience and use because it eliminates the requirement for online transaction validation via the customers' computer, tablet or mobile device.

In a fifth embodiment of the present invention the customers debit cards and credit cards, or the first and second components, utilize traditional credit card technology with magnetic stripes. In this case the transaction is approved at the time of the purchase but processing of the transactions are handled in batches requiring for online transaction validation via the customers' computer, tablet or mobile device. Consequently this fifth embodiment takes a longer time for payment processing than the fourth embodiment using smart card technology. However it also offers the customer the added security option of confirming every transaction via computer or mobile device.

The present invention, in all its various embodiments, offers numerous advantages for customers over existing digital currency wallets and debit card products. These advantages include increased online security of digital currency assets, the use of digital currency for both credit and debit card transactions with any merchant or vendor that accepts credit or debit cards for fiat currency transactions, the use of computers or mobile devices with any merchant that accepts digital currency transactions, and the supply of credit lending funds to credit card customers using a distributed pool of investors and lenders. Vendors and credit card issuers also benefit from various embodiments of the present invention due to the dramatic reduction of security risks associated with online digital wallets, the resultant increased commercially feasibility of digital currency credit card products, the ability to fund credit card lending using existing debit card customers and 3^{rd} party investors, and the increasing mainstream consumer appeal of easy-to-use digital currency banking products. Various other potential embodiments of the invention may be developed without departing from the scope and ambit of the invention.

### BRIEF DESCRIPTION OF THE DRAWINGS

By way of example, employment of the invention is described more fully hereinafter with reference to the accompanying drawings, in which:

FIG. 1 shows a schematic overview of the integration of a vendors digital currency banking platform with customers, merchants and credit card associations using Bitcoin (BTC) and USD ($) as examples of digital and fiat currencies.

FIG. 2 shows an example of a spliced/paired encryption process using simple coding algorithms applied to Bitcoin Base 58 private and public keys.

FIG. 3 shows a schematic overview of an embodiment of a digital currency storage, payment and credit lending platform comprising eight distinct hardware and software components using a spliced/paired online digital wallet design.

### DETAILED DESCRIPTION OF THE INVENTION

According to a first aspect of the present invention, there is a system and method for a vendor to provide customers with a highly secure digital currency storage, payment and credit lending platform comprising various hardware and software components that enables;
customer digital currency assets to be securely stored online using a spliced/paired digital wallet technology that separates digital currency private key information into two separate spliced encrypted private keys, with one spliced key stored on the customers computer, tablet, smart mobile phone or smart credit/debit card, the other spliced key stored on the vendors online computer server or network, thereby preventing online theft of both spliced private keys from a single security attack;
customer payments to third party merchants in fiat currency to be made using a digital currency credit card or debit card with traditional merchant credit card processing hardware, and the automatic deduction of the converted transaction amount from the customers' digital currency account stored in a secure spliced/paired digital wallet account;
customer payments to third party merchants in digital currency to be made using a software program operating on the customers internet connected computer, tablet or mobile phone device that connects to the vendors online server and automatically deducts the transaction amount from the customers' digital currency account stored in a secure spliced / paired online digital wallet account;
regular back-up security against potential loss of digital currency assets or spliced private key information on either the customers or vendors computer device to be made via the storage of both vendor and customer spliced private keys, or storage of encoded pairs of both spliced private keys, on the secure vendors' offline server that is not connected to the internet; and
funding of customer digital currency credit cards to be sourced and managed using a software program operating on the vendors online server network that connects or matches credit card applicants to credit lenders that exist as a distributed peer-to-peer network of lenders/investors, that may or may not include existing debit card customers with digital currency assets stored in a secure spliced/paired online digital wallet account.

The operator or owner of the present invention, namely the card issuer and vendor of the digital currency banking platform, has the ability to charge customers fees for goods and services including but not limited to, credit and debit card devices, payments and transactions in either fiat or digital currency, secure digital currency storage, currency conversion and exchange, account management and credit management services. The vendor benefits from operating a profitable digital currency payment, storage and credit lending platform that contains very little inherent risk from online theft, fraud, loss or customer credit default. The customers benefit from access to a digital currency banking platform that is highly secure, easy-to-use, widely accepted with merchants, and for the first time offers customers digital currency credit card products. The credit lender, micro-investor or digital currency debit card customer benefits from being able to earn significant interest rate returns in digital currency from investing relatively small amounts in high return credit card investment products that contain a significantly reduced risk of loss.

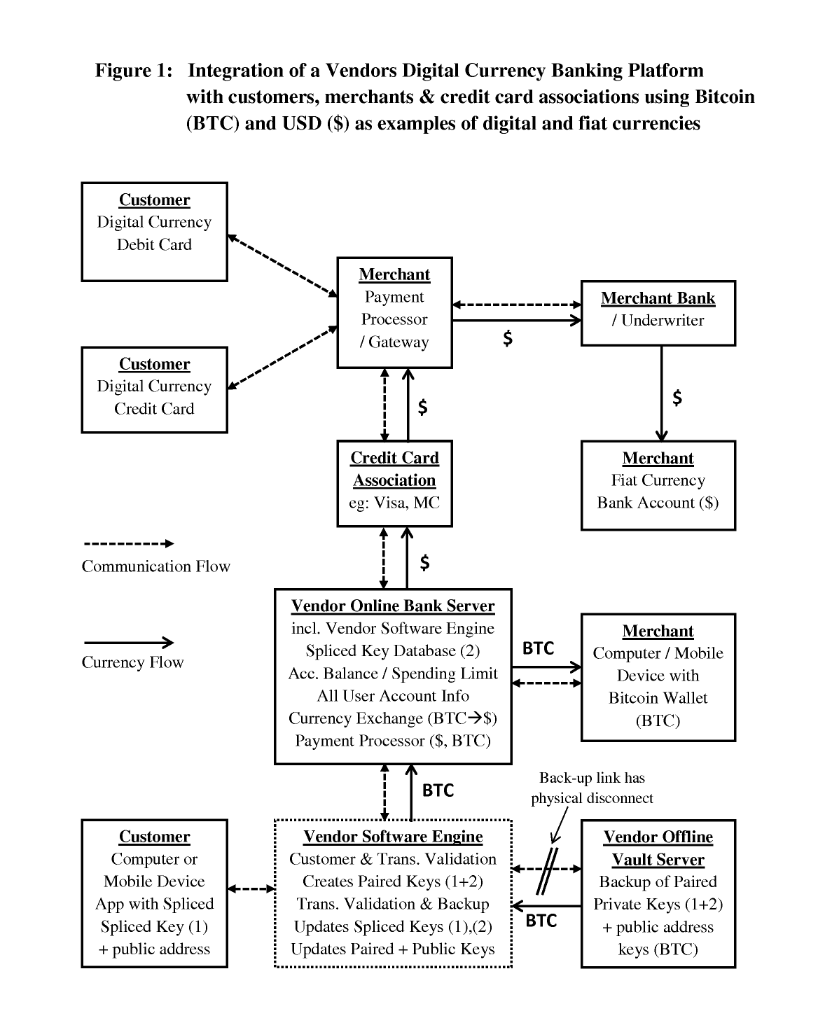

The integration of the present invention with customers, merchants and credit card associations using bitcoin (BTC) and US dollars ($) as typical examples of digital and fiat currencies is described in FIG. 1. The customer can use a digital currency credit or debit card to make purchases with third party merchants in US dollars via conventional merchant credit card payment processors and gateways that interface with traditional credit card associations including, but in no way limited to, Visa, MasterCard, American Express and Diners Card. The vendors' online banking platform processes and completes payments in US dollars to credit card associations and payments in bitcoin directly to merchants for all approved and confirmed customer purchases. The banking platform also converts all fiat currency transaction amounts from US dollars into bitcoin, charges any transaction fees applicable, deducts all converted fiat and digital currency transactions from the customers bitcoin wallet, splices and encodes new private key information on the customers computer device and vendors online server, and makes a backup of the paired private key information on the vendors offline server or network. In the case that credit and debit card products use conventional magnetic stripe storage of information, transaction approval from the vendor can be received by the merchant almost instantaneously via the verification of stored account balances or spending limits. However transaction processing with magnetic striped cards may take longer as it requires a subsequent online connection between the customers' computer or mobile device with the vendors online server platform for the customer to formally confirm the transaction. In the case that credit and debit card products use the latest smart card technology with programmable onboard integrated circuitry for storage of information, transaction approval and processing can be completed in a single process at the time of the purchase.

The present invention comprises in part a unique and novel digital wallet technology that can be described as a spliced/paired online wallet technology. Conventional digital wallets typically comprise, but are not limited to, a private software key in excess of fifty characters long and a shorter public key or address around thirty characters long. The private key is required to access or use digital currency assets stored in accounts associated with the public address. Theft or loss of the private key typically results in the permanent loss of all digital currency assets. However loss of the public address is not detrimental as it can be recalculated or reformulated using the private key. Regardless of whether the private key is retained by the customer, the wallet vendor or both, if it is stored on any server, computer or mobile device that is connected to the internet it is vulnerable to online theft or loss. Consequently conventional online digital wallets are susceptible to online theft, fraud, loss or deletion of the private key information which commercially limits the amount of digital currency typically stored by customers in an online wallet or debit card. Large amounts of digital currency are more often stored in much more secure offline digital wallets that are difficult for the customer to access and use.

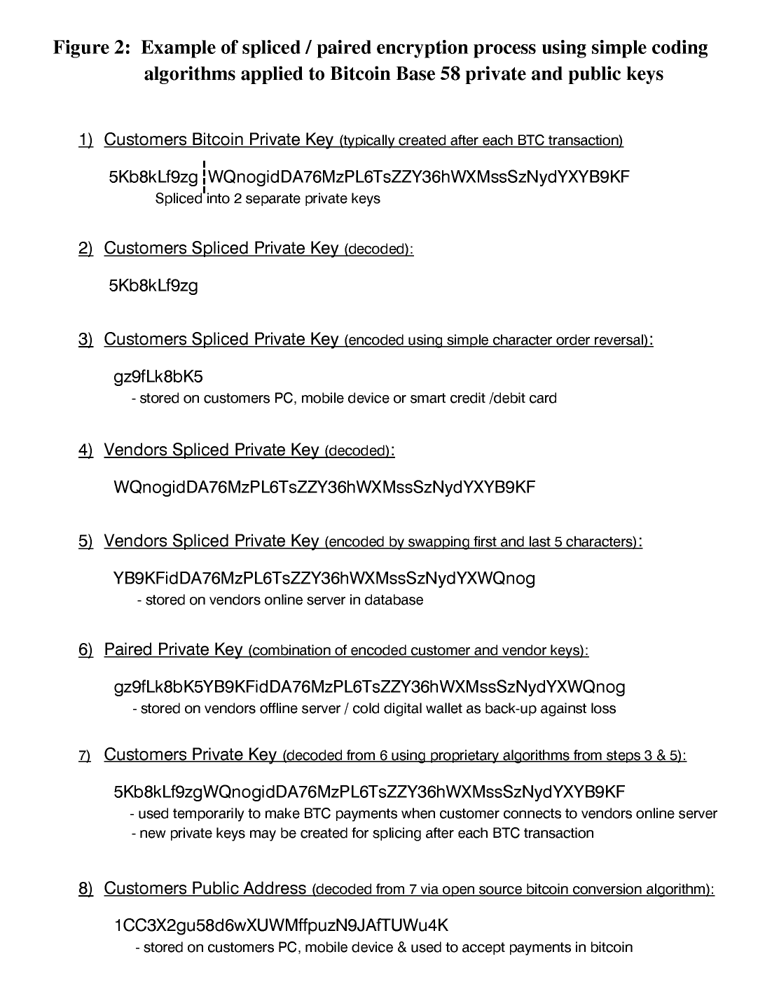

In contrast to conventional online digital wallets, present invention comprises a novel spliced/ paired digital wallet design involves the private software key being separated or spliced into two separate smaller keys that can only access the contents of a digital wallet when paired together, but cannot access a digital wallet separately on their own. The concept is for the customer to retain one spliced private key and the card issuer, wallet vendor or digital bank to retain the other spliced portion of the private key for trusted payment processing and storage backup services. Most of the time, when a transaction is not being executed, the spliced private key information stored on either the vendors computer server or the customers computer device is entirely useless to an online thief or computer hacker who is successful in penetrating computer security. The two spliced keys are only ever susceptible to online theft when the customer decides to execute a digital currency transaction via connecting to the wallet vendors' online platform server via the internet. An example of a spliced/paired encryption process using simple coding algorithms applied to Bitcoin Base 58 private and public keys is described in FIG. 2. Note that in most practical real world cases a much more complicated set of coding algorithms would be used to encode spliced private keys and create paired private key combinations.

When a purchase transaction is initiated by a customer the vendors online platform server and software engine first confirms the identity of the customer, temporarily pairs the two spliced private keys together, executes a digital currency transaction using the paired wallet information, updates the public address and spliced private key information on both the vendors platform and the customers computer device, stores a backup copy of the updated public address and paired key information on an offline server network, remote digital storage device or cold wallet that is not connected to the internet, and then finally destroys the temporarily paired key information on the platform server. If a customer makes several transactions a day then the paired private key might only be susceptible to online theft for a few minutes a day. However even this small period of susceptibility to online theft of the paired private key information is virtually eliminated if the platform server only allows access from a single customer device at any one time and implements sufficiently stringent customer identification and transaction security protocols. Moreover, the customers' digital currency assets can be fully protected against both theft and loss because the only place the customers paired private key information is stored is on the wallet vendors' highly secure offline server network, cold wallet or digital vault which is not physically connected to the internet. If the customer loses their spliced key information via the physical loss of a computer, mobile device, the deletion of stored software files or the physical loss of a credit/debit card then the spliced key information can be restored on their device using the paired key information stored on the vendors offline server network, cold wallet or digital vault. Consequently spliced/paired digital wallet technology represents a significant improvement in the security of digital assets against both theft and loss compared to conventional digital wallet technology.

Spliced/paired digital wallet technology enables dramatically increased security against online theft or loss, the use of traditional credit and debit card payment processing systems, and the use of conventional digital currency payment processing systems that are accessed via the internet on a personal computer or mobile device. In one possible embodiment spliced/paired digital wallets may be configured as a novel class of encryption or crypto-currency that exists on top of existing digital or crypto-currencies such as Bitcoin and Litecoin. A dramatic reduction in online security risk combined with the increased ease of use for customers makes it significantly more attractive for credit issuers and lenders to accept the risks involved in issuing digital currency credit card accounts to approved customers. In addition the increased security of digital currency in spliced/paired wallets promotes larger transactions to be more acceptable to debit card customers. Consequently spliced/paired digital wallet technology has the potential to ensure a very high degree of online security and safety against potential theft or loss of stored assets, thereby enabling credit card and debit transactions to be more safely accepted by credit card issuers and customers.

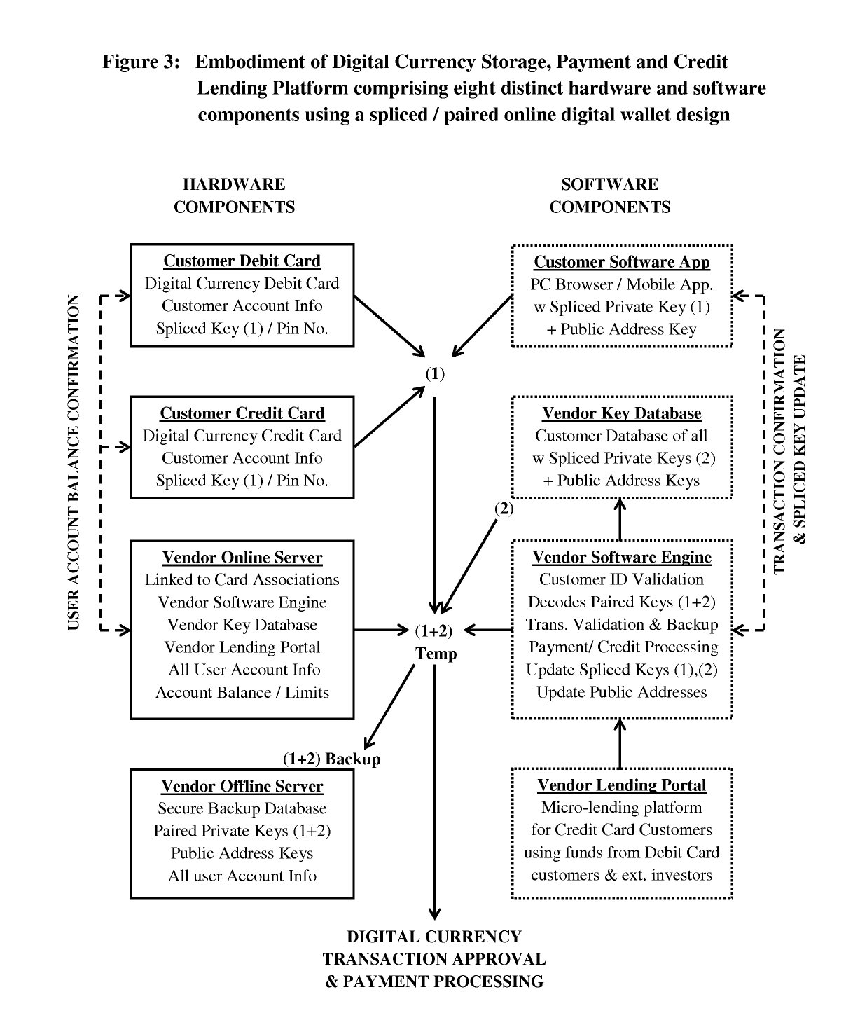

In a first embodiment of the present invention described in FIG. 3, although this should not be seen as limiting the invention in any way, a secure digital currency storage, payment and credit lending platform is provided to customers by a digital currency card issuer, banking institution or wallet vendor; and consists of the following eight distinct components of hardware and software;
a first component being of hardware, namely a digital currency debit card issued by the vendor to the customer that enables the use of converted digital currency assets stored in a spliced/paired digital currency wallet account for the purchase of goods and services in fiat currency with existing merchant credit/debit card payment processing infrastructure and credit card associations;
a second component being of hardware, namely a digital currency credit card issued by the vendor to the customer that enables the use of converted digital currency assets, borrowed from a pool of investors or credit lending network, and stored in a spliced/paired digital currency wallet account for the purchase of goods and services in fiat currency with existing merchant credit/debit card payment processing infrastructure and credit card associations;
a third component being of hardware, namely the vendors online server platform or network that stores the vendors spliced private key information and runs the vendors software engine for customer validation, processing of digital currency and credit/debit card transactions and peer-to-peer lending of credit to customer accounts;
a fourth component being of hardware, namely the vendors offline server platform, network, cold wallet or digital vault that is safely located, securely operated and physically disconnected from the internet and is used to regularly store updates of the back-up copy of the customers' account information, paired private key and public address information in case either vendors or customers spliced private key information is lost, deleted or corrupted;
a fifth component being of software, namely the customers portion of the spliced digital currency wallet account that includes the customers digital wallet public address and the customers splice or portion of the customers digital wallet private key, that can be stored on customers credit/debit card and the customers computer or mobile device;
a sixth component being of software, namely a database of the vendors portion of the spliced digital currency wallet account that includes the customers digital wallet public address and the vendors splice or portion of the customers digital wallet private key, that is stored on the vendors online server platform or network;
a seventh component being of software, namely the vendors software engine that runs on the vendors online server platform, and performs numerous functions including, but not limited to (a) validation of customer identity, account balances and spending limits (b) interfacing with the credit card associations and digital currency accounts for transaction validation, (c) temporary pairing of spliced keys to produce a complete paired private key, (d) using the paired private key for digital currency transactions and conversions into fiat currency transactions, (e) updating and encryption of spliced private keys stored on the customers computer and vendors online server platform, (f) updating customer card account balances and spending limits, (g) creation of a back-up of the paired private key stored on the vendors offline server network before deleting it on the online server, and (h) interfacing with a distributed peer-to-peer lending network for funding credit card customer accounts; and
an eighth component being of software, namely the vendors peer-to-peer lending platform or network that connects customers applying for digital currency credit card funds with a pool or distributed network of digital currency lenders which may include both external third party credit investors and existing customers with debit card accounts, stores all existing credit balances and spending limits, and manages all customer credit card contracts, fees and interest charges on behalf of the lender, or pool of lenders.

In a second embodiment of the present invention the vendors offline server platform, or the eighth component, can also be used to store and validate customer card account balances and spending limits, and to interface directly with credit card associations for validation of customer credit and debit card transactions. In this embodiment the vendors' online server platform is not required for the storage of customer account balance and spending limit information in a database used for validation and processing of credit/debit card transactions. Consequently this second embodiment of the present invention may offer improved credit/debit card security benefits for the vendor, and also improved security ease-of-use benefits for customers.

In a third embodiment of the present invention the vendors database of spliced portions of customer private keys and user account information, or the sixth component, may exist as a software block-chain that is stored on a large distributed peer-to-peer network of customer computers instead of the vendors online server network. This configuration may have advantages in terms of providing increased security without customers having to place total trust in the vendor for digital asset security. In this case the database of vendor private keys would be stored on all customers' computers and mobile devices for pairing with the customers' portion of the private key. The block-chain may be decoded for a specific private key by either the vendors' software engine or on the customers' computer or mobile device. This configuration has greater stability and transparency for the vendors' key database and may be virtually immune to the loss of digital currency assets from the loss or deletion of the private key software. However, unlike the first two embodiments described, this third embodiment is not totally immune to theft of assets from online fraud or computer hacking as the customer possesses both portions of the private key necessary to confirm transactions. Nonetheless the storing of both portions of the spliced/paired digital wallet existing on the customers computer or mobile device offers better security than conventional digital currency wallets that currently exist on customer devices, primarily due to the added layer of the proprietary encryption engine required to pair the two keys together to form a single private key.

In a fourth embodiment of the present invention the customers debit cards and credit cards, or the first and second components, utilize smart card technology with embedded integrated circuitry. In this case the customers' spliced private key can be stored and updated directly on the card when being used for fiat currency transactions. Consequently bitcoin transactions using a smart debit or smart credit card can be quickly approved and processed at the time of the purchase, and updated spliced keys can be stored locally on the card. Private key updates and transaction information can be updated on the customers computer or mobile device when the customer next logs onto the vendors online server. The customers' updated private key information is permanently stored as a back-up on the vendors' offline server, and may be temporarily stored on the vendors online server for updating customer computers and mobile devices.

In a fifth embodiment of the present invention the customers debit cards and credit cards, or the first and second components, utilize traditional credit card technology with magnetic stripe encoding for data storage. In this case the transaction is approved at the time of the purchase by confirming the customers' account balance or spending limit. However because the customers spliced private key information is not stored and updated locally on the magnetic credit card, processing of digital currency payments and transactions may be handled in batches requiring the customer to log-on to the vendors online server with their computer or mobile device. Consequently this may take a significantly longer time for payment processing unless a payment confirmation message is sent to the customers computer or mobile device. Nonetheless conventional credit card transactions typically take a few days to fully process and automatic batch processing of transactions whenever the customer logs onto the vendors online server is a highly feasible solutions. Moreover, customer confirmation of each transaction after vendor approval via text, email or internet application to a computer or smart mobile device is a feature that many customers may want for additional security reasons.

In most preferred embodiments of the present invention discussed here, although this should not be seen as limiting the invention in any way, the invention comprises four key hardware components and four key software components that form an integrated payment and banking platform. The platform interfaces with external digital currency exchanges, credit card associations such as Visa and MasterCard, 3^{rd} party investors and credit lenders, and customers via credit cards, debit cards, computers and mobile devices. The platform also has the capability for customers to confirm each individual credit/debit card transaction via internet software application, email or SMS/text notification for additional levels of transaction security. For computer hackers or online thieves to steal the customers' private key from the spliced/paired digital currency wallet they must first gain a copy of the customers portion of the private key from their personal computer or mobile device, second gain a copy of the vendors portion of the private key from the vendors online server, and third gain a copy of the vendors software engine and platform that encodes, splices and pairs the two keys from the vendors online server. It is important to realize that the vendors' software engine is a large, proprietary piece of software that is continually running on the highly secure vendor online server network that only approved customers and the vendor have access to. In other words they not only have to steal both codes from two different parties, they would also have to steal a proprietary online banking platform while it was operating. Consequently, even in the highly inconceivable case that an online thief could acquire all three pieces of software code, their identity would be well known to the vendor with sufficient customer approval and validation procedures.

In summary of the specific details discussed herein, the present invention can be described as a highly secure financial banking platform that uses spliced/paired digital wallet technology for the storage of digital currency, uses digital currency credit and debit cards for fiat currency transactions with merchants, uses internet connected computers and mobile devices for digital currency transactions with merchants, and uses a distributed network of debit card customers and 3rd party lenders for the provision of credit lending for credit card customers. The process of splicing digital currency private key software into two portions held by two different trusted parties combined with proprietary encoding, splicing and pairing software virtually eliminates the possibility of online theft of digital currency. The process of making back-ups of the paired keys and only storing these keys on a secure offline server or cold wallet eliminates the possibility of losing digital currency from the loss of private key software stored on customer computer or mobile devices. Consequently the present invention is highly secure against both theft and loss of private keys and public addresses.

The present invention offers numerous advantages for customers over existing digital currency debit card products including increased online security of digital currency assets, the additional use of digital currency with credit card products, the widespread acceptance of digital currency with any merchant or third party that accepts credit cards for conventional fiat currency transactions, the use of computers or mobile devices with any merchant that accepts digital currency transactions, and the supply of credit lending funds to credit card customers using a distributed pool of investors and lenders. The present invention also offers numerous advantages for digital currency card issuers, banking institutions or wallet vendors including the dramatic reduction of security risks associated with online digital wallets, the increased commercially feasibility of digital currency credit card products, the ability to fund credit card lending using existing debit card customers and 3^{rd} party investors, and the increasing mainstream consumer appeal of digital currency credit and debit card products as digital currencies grow in popularity, currency value and market stability. The present invention represents a significant and innovative advance in online banking technology and digital currency storage, payment and credit lending products. Various modifications may be made in details of design and construction of the invention and its component parts, process steps, parameters of operation etc. without departing from the scope and ambit of the invention.

What is claimed is:

1. A system and method for the secure online storage of data payloads or computer software files comprising critical private key information for digital currency wallets or crypto-currency accounts, via a spliced/paired software encryption engine and dispersed storage architecture that automatically performs the steps of;
splicing or dividing each data payload into two or more smaller separate file portions, with each individual file portion not containing enough data or information to be considered critical, valuable or useful in itself;
encrypting or encoding all separate file portions using a software algorithm or encryption formula that significantly changes or disguises the original content of each file portion;
storing or saving one of the encrypted file portions locally on a user controlled device such as a personal computer, notebook computer, smartphone or tablet device;
storing or saving the remaining encrypted file portions remotely on an online platform, network or cloud based storage server that is provided by the vendor of the software engine;
storing or saving a back-up copy of all encrypted file portions remotely on an offline storage platform, network, cold wallet or digital vault that is physically disconnected from the internet and provided by the vendor, in case either the vendors or the users online spliced file information is lost, deleted or corrupted;
identifying and authorizing the user and the user controlled device to retrieve or access all encrypted file portions stored locally and remotely online;
retrieving or accessing all local and remote online encrypted file portions stored on the user controlled device and the online platform or network, contingent upon user identification and authentication being successfully performed;
decrypting or decoding of all retrieved encrypted file portions and combining or pairing the resultant decrypted file portions into a temporary version of the original data payload or computer file;
using the paired temporary version of the original data payload with any software application that can view, modify, edit or change the critical contents of the original data payload contingent upon user authorization, including but not limited to any software application that executes a financial transaction or digital currency payment;
updating the dispersed portions of all encrypted files stored on the user device, online network and offline back-up server with any authorized changes or modifications to the original data payload via the splicing, encryption and storage of the modified temporary version of the original data payload; and
deleting or destroying the modified temporary version of the original data payload once it has been successfully spliced into updated file portions which are encrypted, dispersed and stored on the user device, online network and offline back-up server.

2. A system and method for the secure online payment and transfer of digital currency or crypto-currency assets from a user or customer account to a third party merchant account for the provision of goods or services, via a software platform and storage service provided by a vendor that comprises the essential components of;
a vendor software engine that manages all secure online banking and payment processes, including but not limited to user authentication, user device authentication, digital currency wallet splicing, digital currency wallet encryption, digital currency online wallet storage, digital currency offline back-up storage, digital currency payment processing, digital - fiat currency exchange transactions, communications with credit card associations, fiat currency payments to merchants and authorization of digital currency debit card transactions;
a digital currency online wallet in which the users digital currency private key information is stored online in a dispersed manner using a spliced/paired storage architecture that splices or divides critical private key data into two or more encrypted portions stored separately on the users' computer device and the vendors online server or cloud storage platform;
a vendor online server that hosts the vendor software engine and stores the vendors encrypted file portion of the digital currency online wallet;
a vendor offline server or cold storage vault that is physically disconnected from the internet and used to store a copy of all encrypted portions of the digital currency online wallet, in case either the vendors or the users online spliced file information is lost, deleted or corrupted; and
a digital currency debit card issued by the vendor to the user or customer that enables the use of converted digital currency assets stored in the users spliced/paired digital currency online wallet for the purchase of goods and services in fiat currency using existing merchant debit card payment processing infrastructure and credit card associations;

3. A system and method for a digital currency credit card device issued by a vendor to the user or customer that enables the use of borrowed digital currency funds to be converted into fiat currency for the purchase of goods or services using existing fiat currency merchant credit card payment processing infrastructure and credit card associations, and includes the essential components of;
a vendor online banking platform that authorizes credit card transactions with merchants in fiat currency, integrates with existing fiat currency merchant credit card payment processing infrastructure and credit card associations, manages digital—fiat currency exchange transactions, manages the storage of digital currency funds in a digital currency online wallet, processes digital currency transactions and manages the borrowing of digital currency funds for the user with a digital currency credit lending network;
a digital currency online wallet in which the users digital currency private key information is stored online in a dispersed manner using a spliced/paired storage architecture that splices or divides critical private key data into two or more encrypted portions stored separately on the users' computer device and the vendor banking platform or online server;
a vendor offline server or cold data storage device that is physically disconnected from the internet and stores a back-up copy of all encrypted file portions from the vendor online banking platform and the users' computer device or smart device; and
a digital currency credit lending network that provides funds in digital currency to the user or customer, and stores these borrowed funds in the spliced/paired digital currency online wallet.

4. The system and method of claim 1, wherein the data payload or computer software file does not comprise private key information for a digital currency online wallet, and instead comprises other types of confidential, personal or financial information including but not limited to credit card details, bank account details, internet usernames, internet passwords, social security numbers, tax identification numbers, passport details and drivers' license details.

5. The system and method of claim 1, wherein the data payload or computer software file does not comprise private key information for a digital currency online wallet, and instead comprises information for other document file formats including but not limited to image files, video files, audio files, text files, database files, legal documents, financial documents, medical history documents, word processor documents, presentation documents, spreadsheet documents and email documents.

6. The system and method of claim 1, wherein the vendor online server and vendor offline back-up server contain additional stored information about the users account, including but not limited to username and password, user account activity, user account history, user account balances, user account preferences, user account payment details and digital fingerprints of user controlled devices.

7. The system and method of claim 1, wherein the vendors online database of spliced encrypted file portions of the data payload exist as a software block-chain stored on a distributed peer-to-peer network of multiple user computer devices instead of a single vendor online server network.

8. The system and method of claim 1, wherein the vendors online database of spliced encrypted file portions of the data payload exist as a dispersed and distributed database stored on an integrated collection of multiple independent third party cloud storage service providers instead of a single vendor online server network.

9. The system and method of claim 2, wherein the digital currency is a commonly used digital currency or crypto-currency asset class, including but not limited to Bitcoin, Litecoin, Dogecoin, Mastercoin, Ethereum, Ripple and any of their derivative asset classes.

10. The system and method of claim 2, wherein the vendor online server is used to store and validate customer debit card account balances and spending limits, and to interface directly with credit card associations for validation of customer debit card transactions.

11. The system and method of claim 2, wherein the vendor offline server is used to store and validate customer debit card account balances and spending limits, and to interface directly with credit card associations for validation of customer debit card transactions.

12. The system and method of claim 2, wherein the digital currency is a commonly used digital currency or crypto-currency asset class, including but not limited to Bitcoin, Litecoin, Dogecoin, Mastercoin, Ethereum, Ripple and any of their derivative asset classes.

13. The system and method of claim 3, wherein the vendors online banking platform is used to store and validate customer credit card account balances and spending limits, and to interface directly with credit card associations for validation of customer credit card transactions.

14. The system and method of claim 3, wherein the vendors offline server is used to store and validate customer credit card account balances and spending limits, and to interface directly with credit card associations for validation of customer credit card transactions.

15. The system and method of claim 3, wherein the digital currency credit lending network comprises of a pool of digital currency investors or a network of online lenders who derive profit from charging interest and fees directly to individual users or customers who borrow digital currency funds from an individual investor or lenders.

16. The system and method of claim 3, wherein the digital currency credit lending network comprises of a pool of digital currency investors or a network of online lenders who derive profit from charging interest and fees to the manager of the total pool of funds for lending, which may be the vendor of the online banking platform or a third party fund manager.

17. The system and method of claim 3, wherein the digital currency is a commonly used digital currency or crypto-currency asset class, including but not limited to Bitcoin, Litecoin, Dogecoin, Mastercoin, Ethereum, Ripple and any of their derivative asset classes.

18. The systems and methods of claim 2 and claim 3, wherein the digital currency credit lending network comprises of a pool of digital currency debit card users who have digital currency assets stored in digital currency online wallets that can be used to fund individual loans directly to digital currency credit card users or customers.

19. The systems and methods of claim 2 and claim 3, wherein the digital currency credit lending network comprises of a pool of digital currency debit card users who have digital currency assets stored in digital currency online wallets that can be used to invest in a managed pool of investment funds for lending to digital currency credit card users or customers.
